(19) United States
(12) Patent Application Publication
(10) Pub. No.: US 2007/0119842 A1
(43) Pub. Date: May 31, 2007

(54) Flexible lamination and a method thereof

(76) Inventors: Jay Ku, Yangmei Township (TW); Han-Chieh Liang, Yangmei Township (TW); Chang-Yao Wang, Yangmei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/586,532

(22) Filed: Oct. 26, 2006

(30) Foreign Application Priority Data
Nov. 29, 2005 (TW) 94141957

(51) Int. Cl. H05B 3/00

(52) U.S. Cl. 219/211

(57) ABSTRACT

The method for a flexible lamination includes: providing a cloth foundation having temperature resistant properties; sewing heating wire on the cloth foundation; providing a first outer cloth and a second outer cloth having high temperature resistant properties and being individually disposed on an upper surface and a lower surface of the cloth foundation; coating a thermoplastic between the first outer cloth and the cloth foundation, and between the second outer cloth and the cloth foundation; pressing and heating an outer surface of the first outer cloth or the second outer cloth of the first outer cloth and the second outer cloth so that they individually adhere to the upper and lower surfaces of the cloth foundation; thereby it becomes resistant to high temperatures, and is not easily oxidized.

### BACKGROUND OF THE INVENTION

1. Field of the Invention

The present invention relates to a flexible lamination and a method thereof, and in particular to a flexible lamination that can keep various products warm, and can be extensively applied throughout industry, for use with electric equipment, for beauty treatments, healthcare, food preservation, agriculture, and electric products.

2. Description of Related Art

Soft silica gel laminations have sturdy structures, yet are quite flexible. They are often applied to piping for industry, to heating troughs, and can also be used for heating filling equipment and supersonic cleaning equipment. Referring to FIG. 1, a silica gel lamination includes a heating wire layer 1a and two silica gel layers 2a. The two silica layers are attached to the upper and lower surfaces of the heating wire layer 1a a via a vulcanized treatment to laminate the three-tiered structure.

However, the silica gel layer 2a of the silica gel lamination oxidizes quickly in high temperature. Subsequently, the silica gel layer 2a often produces cracks, comes off, and suffers from electrical leakages. Silica gel is expensive, and non-vulcanized silica gel has expires rapidly; hence it increases production costs. Moreover, the silica gel layer 2a of the silica gel lamination is not suitable for use in high temperatures. Nowadays, due to the above-mentioned defects, Teflon (PTFE) is commonly used in place of silica gel.

Referring to FIG. 2, a conventional Teflon lamination includes an upper layer 3a, a middle layer 30a, and a lower layer 31a, which are made of a Teflon cloth, and a heating wire 4a. The middle layer 30a is sewed on to the upper layer 3a. The Teflon lamination further comprises rows of a cotton thread 5a that are sewed parallel and equidistant from each other between the upper layer 3a and the middle layer 30a. The heating wire 4a is disposed manually between the intervals of each of the cotton threads 5a.

This process requires a large amount of time and work to dispose the heating wire 4a manually between the intervals of each of the cotton threads 5a. Furthermore, the wiring density of the heating wire 4a is limited by the intervals of the cotton threads 5a. The heating wire 4a is easy deformed and twisted when the heating wire 4a is disposed on the cotton thread 5a. Hence, the path of the heating wire 4a can be deformed by pulling or dragging the Teflon lamination so that the Teflon lamination can change the impedance in part, the temperature will not be uniform, power will be affected, and public safety endangered.

Accordingly, as discussed above, the prior art still has some drawbacks that can be improved. The present invention aims to resolve the drawbacks in the prior art.

### SUMMARY OF THE INVENTION

It is an object of the present invention to provide a flexible lamination and a method thereof, wherein the flexible lamination is formed by the two Teflon cloths covering the upper and lower surfaces of the Teflon cloth with a heating wire. The heating wire is directly sewed on to the Teflon cloth for the purposes of shortening the time required for wiring, fast manufacture, high temperature resistant, and reducing oxidation.

To achieve the object of the present invention, the flexible lamination includes a cloth foundation having high temperature resistant properties; a heating wire sewed on to the cloth foundation; a first outer cloth having high temperature resistant properties disposed on an upper surface of the cloth foundation; and a second outer cloth having high temperature resistant properties disposed on a lower surface of the cloth foundation.

In the preferred embodiment, wherein the cloth foundation, the first outer cloth, and the second outer cloth are fibrous cloth containing Teflon or are pure Teflon cloth. The thermoplastic (PTFE, polytetra fluoroethylene FEP, fluorinated ethylene propylene or PFA, perfluoroalkoxy ) acts as an adhesive between the first outer cloth and the cloth foundation. The thermoplastic (PTFE, FEP, or PFA ) acts as an adhesive between the second outer cloth and the cloth foundation.

The present invention provides another method for the flexible lamination that includes (a) providing a cloth foundation having temperature resistant properties; (b) sewing heating wire on the cloth foundation; (c) providing a first outer cloth and a second outer cloth having high temperature resistant properties and being individually disposed on an upper surface and a lower surface of the cloth foundation; (d) coating a thermoplastic between the first outer cloth and the cloth foundation, and between the second outer cloth and the cloth foundation; (e) and pressing and heating an outer surface of the first outer cloth or the second outer cloth of the first outer cloth and the second outer cloth individually so that they adhere to the upper and lower surfaces of the cloth foundation.

Numerous additional features, benefits and details of the present invention are described in the detailed description, which follows.

### BRIEF DESCRIPTION OF THE DRAWINGS

The present invention can be fully understood from the following detailed description and preferred embodiment with reference to the accompanying drawings, in which:

FIG. 1 is a cross-sectional view of a silica gel lamination of the prior art;

FIG. 2 is a cross-sectional view of a Teflon lamination of the prior art;

FIG. 2A is a top view of a Teflon lamination of the prior art;

FIG. 3 is a flow chart of a flexible lamination and a method thereof of the present invention;

FIG. 4 is an exploded view of a flexible lamination and a method thereof according to the preferred embodiment of the present invention;

FIG. 5 is a combinative view of a flexible lamination and a method thereof according to the preferred embodiment of the present invention;

FIG. 6 is a cross-sectional view of a flexible lamination and a method thereof according to the preferred embodiment of the present invention;

FIG. 7 is a schematic view of a flexible lamination and a method thereof according to another preferred embodiment of the present invention; and

FIG. 8 is a schematic view of a flexible lamination and a method thereof according to the further preferred embodiment of the present invention.

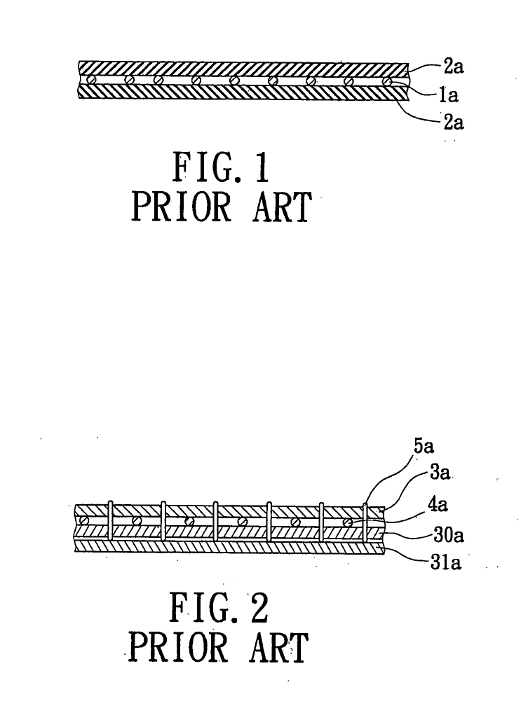

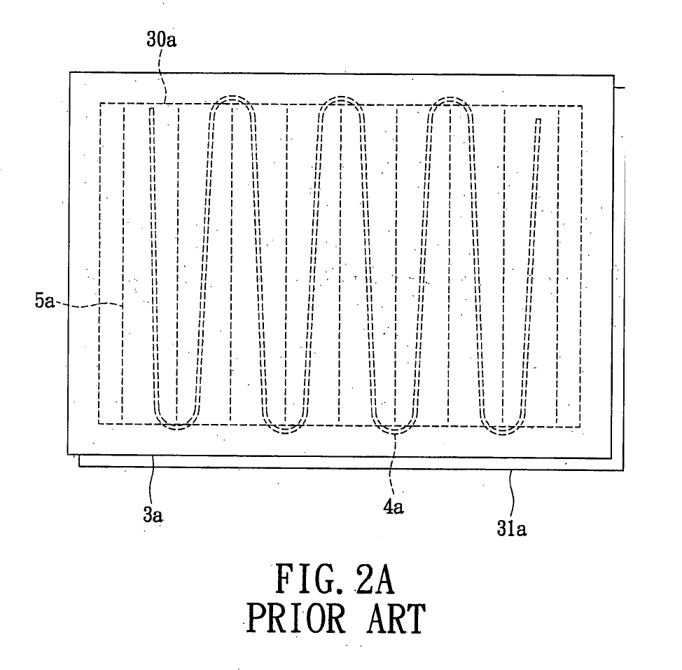

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

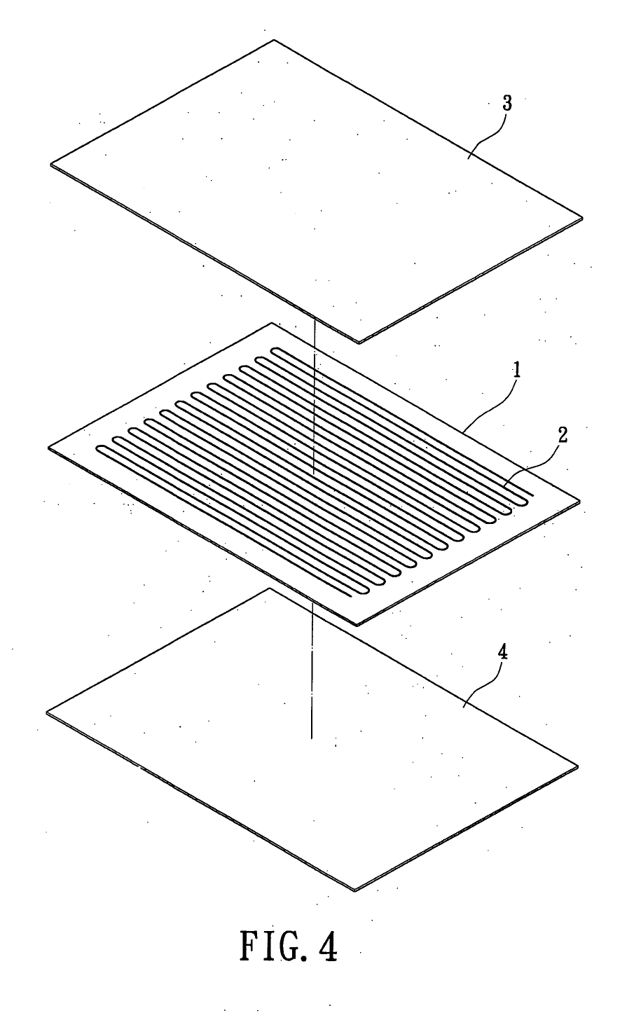

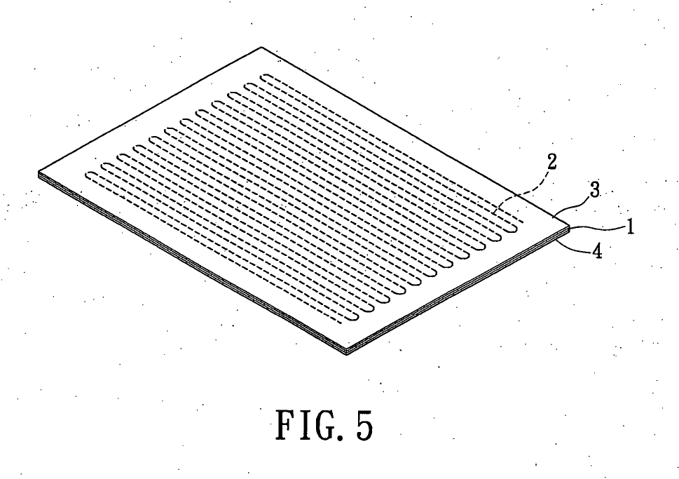

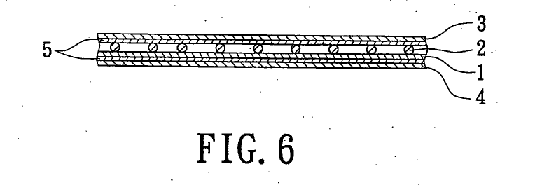

Referring to FIG. 4 to FIG. 6, the present invention provides a flexible lamination and a method thereof that includes a cloth foundation 1, a heating wire 2, a first outer cloth 3, and a second outer cloth 4.

The cloth foundation 1 is a fibrous cloth containing Teflon or is made of pure Teflon cloth. Hence, the cloth foundation 1 has properties of high temperature resistance, acid and base resistance, weather resistance, waterproof, and oxidization resistance.

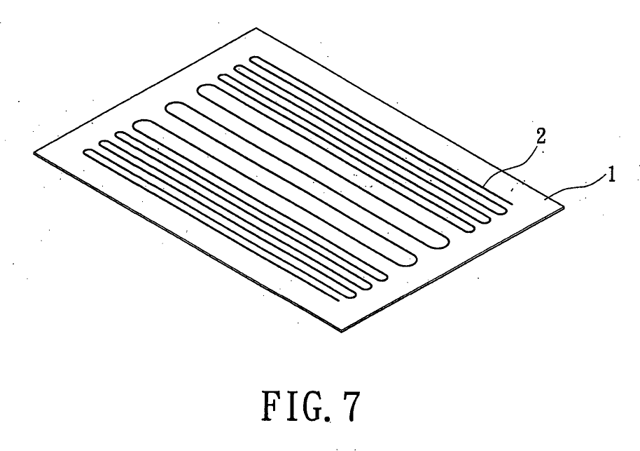

However, the diameters of the heating wire 2 are the as same as the weave of the cloth. The heating wire 2 is disposed on the textile machine; the heating wire 2 is sewed on to the cloth foundation 1 by the textile machine. The patterns of the heating wire 2 are not limited on the cloth foundation 1. Referring to FIG. 7, another type of heating wire 2 is sewed on the cloth foundation 1. The density sizes of the heating wire 2 on the cloth foundation 1 are in accordance to the predetermined patterns of the wiring.

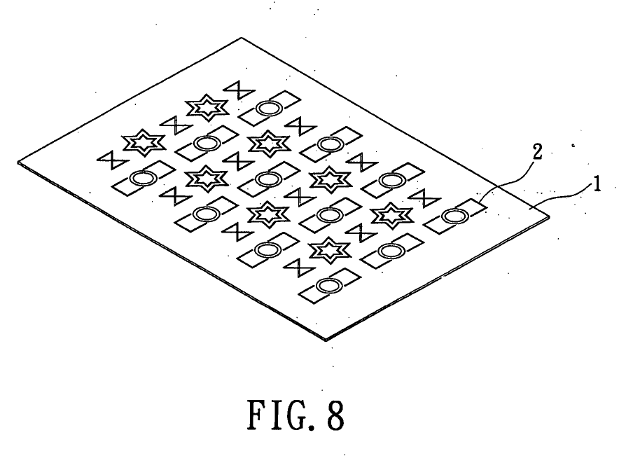

Referring to FIG. 8, the heating wire 2 has a pattern, a star, or a geometrical pattern shape, etc on the cloth foundation 1. In all the kinds of wiring patterns, the interval between the heating wires 2 can be properly adjusted according to need. When the density of the heating wire 2 is large on the cloth foundation 1, the heating wire 2 has a good heating effect. When the density of the heating wire 2 is small on the cloth foundation 1, the heating wire 2 maintains heat well. Hence, the applied scope of the flexible lamination of the present is in accordance to the pattern of the heating wire 2 sewed on to the cloth foundation 1.

The first outer cloth 3 is a fibrous cloth containing Teflon or is made of pure Teflon cloth. Hence, the first outer cloth 3 has the properties of high temperature resistance, acid and base resistance, weather resistance, waterproof, and oxidization resistance. The first outer cloth 3 is disposed on an upper surface of the cloth foundation 1. A thermoplastic 5 (PTFE, FEP, or PFA ) acts as an adhesive between the first outer cloth 3 and the cloth foundation 1.

The second outer cloth 4 is a fibrous cloth containing Teflon or is made of pure Teflon cloth. Hence, the second outer cloth 4 has the properties of high temperature resistance, acid and base resistance, weather resistance, waterproof, and oxidization resistance. The first outer cloth 3 is disposed on a lower surface of the cloth foundation 1. The thermoplastic 5 (PTFE, FEP, or PFA ) acts as an adhesive between the second outer cloth 4 and the cloth foundation 1.

Thereby, the present invention provides a flexible lamination which can be rapidly manufactured, is highly flexible, has high temperature resistance, is acid and base resistant, weather resistant, waterproof, and is resistant to oxidization.

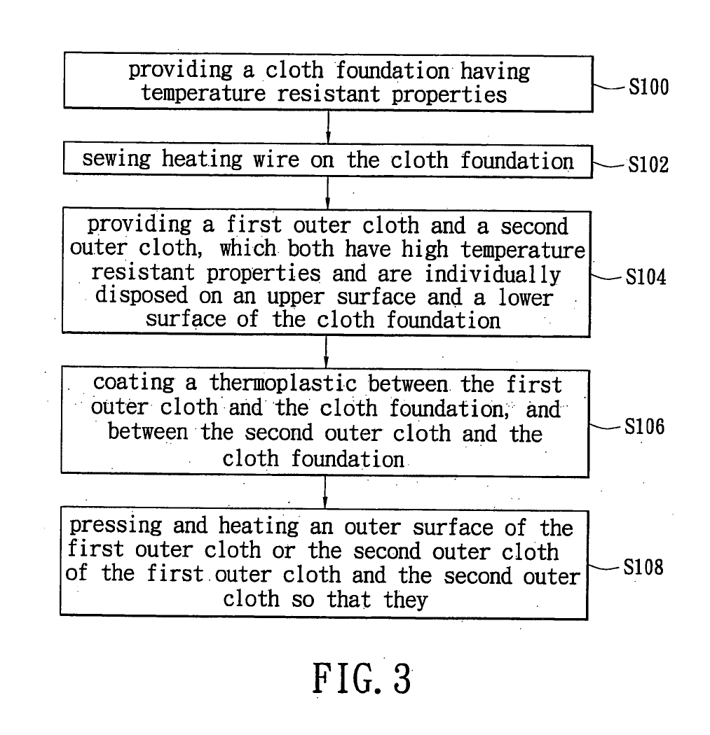

Referring to FIG. 3, the method for a flexible lamination includes: providing a cloth foundation 1 having temperature resistant properties (S1OO); sewing a heating wire 2 on the cloth foundation 1 (S102); providing a first outer cloth 3 and a second outer cloth 4, which have high temperature resistant properties and are individually disposed on an upper surface and a lower surface of the cloth foundation 1 (S104); coating a thermoplastic 5 (PTFE, polytetra fluoroethylene FEP, fluorinated ethylene propylene or PFA, perfluoroalkoxy ) between the first outer cloth 3 and the cloth foundation 1, and between the second outer cloth 4 and the cloth foundation 1 (S106); and pressing and heating an outer surface of the first outer cloth 3 or the second outer cloth 4 for the first outer cloth 3 and the second outer cloth 4 so that they individually adhere to the upper and lower surfaces of the cloth foundation 1 (S108).

The heating wire 2 is directly sewed on to the cloth foundation 1 for the purpose of shortening the time required for wiring, fast manufacture, high flexibility, high temperature resistance, acid and base resistance, weather resistance, oxidization resistance, and so that it is waterproof and not easily oxidized.

The advantages of the flexible lamination and a method thereof of the present invention are as follows:

(1) The heating wire 2 is directly sewed on to the cloth foundation 1; the heating wire 2 is sewed on to the cloth foundation 1 according to a predetermined pattern so that the flexible lamination can be applied widely throughout a number of fields.

(2) The heating wire 2 is directly sewed on to the cloth foundation 1 so that it can be manufactured quickly.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A flexible lamination, comprising:
a cloth foundation having high temperature resistant properties;
a heating wire sewed on to the cloth foundation;
a first outer cloth having high temperature resistant properties disposed on an upper surface of the cloth foundation; and
a second outer cloth having high temperature resistant properties disposed on a lower surface of the cloth foundation.

2. The flexible lamination as claimed in claim 1, wherein the cloth foundation, the first outer cloth, and the second outer cloth are fibrous cloth containing Teflon.

3. The flexible lamination as claimed in claim 1, wherein the cloth foundation, the first outer cloth, and the second outer cloth are pure Teflon cloth.

4. The flexible lamination as claimed in claim 1, further comprising a thermoplastic (PTFE, FEP, or PFA ) that acts as an adhesive between the first outer cloth and the cloth foundation.

5. The flexible lamination as claimed in claim 1, wherein the thermoplastic (PTFE, FEP, or PFA ) that acts as an adhesive between the second outer cloth and the cloth foundation.

6. The flexible lamination as claimed in claim 1, wherein the heating wire has a pattern, a star, or a geometrical patterned shape on the cloth foundation.

7. A method for a flexible lamination, comprising:
providing a cloth foundation having temperature resistant properties;
sewing heating wire on the cloth foundation;
providing a first outer cloth and a second outer cloth, which both have high temperature resistant properties and are individually disposed on an upper surface and a lower surface of the cloth foundation;
coating a thermoplastic between the first outer cloth and the cloth foundation, and between the second outer cloth and the cloth foundation; and
pressing and heating an outer surface of the first outer cloth or the second outer cloth of the first outer cloth and the second outer cloth so that they individually adhere to the upper and lower surfaces of the cloth foundation.

8. The method as claimed in claim 7, wherein the cloth foundation, the first outer cloth, and the second outer cloth are fibrous cloths containing Teflon.

9. The method as claimed in claim 7, wherein the cloth foundation, the first outer cloth, and the second outer cloth are made of pure Teflon cloth.

10. The method as claimed in claim 7, wherein the thermoplastic is a PTFE, FEP, or PFA and acts as an adhesive.

11. The method as claimed in claim 7, wherein the heating wire has a pattern, a star, or a geometrical patterned shape on the cloth foundation.
